(19) United States
(12) Patent Application Publication
(10) Pub. No.: US 2005/0187824 A1
(43) Pub. Date: Aug. 25, 2005

(54) Instructional and promotional publication providing detailed, specific and customizable instruction and assistance

(76) Inventor: Daniel A. Bonneville, San Diego, CA (US)

Correspondence Address: CATALYST LAW GROUP, APC, 9710 SCRANTON ROAD, SUITE S-170, SAN DIEGO, CA, 92121, US

(21) Appl. No.: 11/064,536

(22) Filed: Feb. 23, 2005

Related U.S. Application Data
(60) Provisional application No. 60/546,906, filed on Feb. 23, 2004.

(51) Int. Cl. G06F 17/60; G06N 5/00; G06F 17/00; G09F 1/00; G06F 15/00; G06F 17/21; G06F 17/24

(52) U.S. Cl. 705/14; 283/56; 715/501.1

(57) ABSTRACT

An instructional and promotional publication is disclosed. The brochure offers instructions to a user regarding how to complete a task. The instructional text is co-presented with promotional text, wherein the professionals listed in said promotional text specialize in the subject matter field, are familiar with the text and are available to further explain, customize and/or assist with the instructions to suit an individual user or project. The brochure may be embodied as a multi-page written publication or in an electronic format.

### RELATED APPLICATION

Benefit of priority under 35 U.S.C. 119(e) is claimed herein to U.S. Provisional Application No. 60/546,906 filed Feb. 23, 2004. The disclosure of the above referenced application is incorporated by reference in its entirety herein.

### FIELD OF THE INVENTION

This invention relates -generally to the field of instruction and promotion of services, and in particular to a publication that delivers detailed instructions and assistance for completing a task or subtask thereof.

### BACKGROUND

Traditionally promotional publications comprised only categorized text and graphics related to advertisers in a certain field. Common promotional publications are typically long lists of experts and business relating to a particular subject matter field. One example of such a list is the Yellow Pages® telephone directories. Further examples include advertisement flyers and newspaper and magazine advertisements. Unfortunately, these lists of experts and businesses rarely do more than promote the services that said expert or business provides.

In some instances promotional material may be placed in a publication of similar subject matter, for example, an advertisement for a home remodel business may be placed in a magazine relating to house design ideas; however, these advertisements are merely related in subject matter field only and are not directly targeted to the content of said publication. Even in this example, the advertisers are merely listed in loose relations to the subject matter of the publication. The experience of an expert or business with respect to a particular subject matter of interest within said subject matter field is not expressed.

It is difficult for a user of promotional publications to determine in what sub-portions of an overall task each expert or business specializes. Users of promotional publications generally resort to calling, for example, “plumbers” or “mechanics” to complete a task relating to plumbing or automobiles, respectively. Some more specific advertisements may state that the expert or business focuses on a certain aspect of a task, such as residential plumbing or transmission work. Still, the user is not informed as to whether the expert or business has more specific experience. For example, a user who is rebuilding a classic performance car, may not want any mechanic specializing in transmissions, but instead will want an expert who has experience installing transmissions in performance cars, and maybe, more specifically, in the specific type of car that the user is restoring. Such exhaustive listings are not provided by the long list promotional publications of the public art.

Promotional publications, furthermore, contain no meaningful information that could educate the user about the task. As a result, users frequently call an expert or business to work on a task of interest, paying the expert or business for completion of the entire task. Unfortunately, it is not always the case that the user needs to enter into a business relationship with the expert or business for the entire task, and instead only needs advice or expert services for a small portion of the overall task. For example, a user may have a hobby restoring high performance automobiles. For such a user, the project is one that said user would like to complete himself; however, said user has encountered a problem with a single aspect of the overall project. This type of user would prefer to receive advice and information about the task of interest, and would only want to hire an expert or business as an absolute last resort, and only for the minimum amount of contribution possible. Using the promotional material of the prior art, the user can only scan a list of experts and businesses in the subject matter field, and contact these experts and businesses to hire out the job. In this instance using the prior art, the user will hire the expert or business and the expert or business will complete the task without educating or assisting the user regarding how to attempt the task on his own.

Educating the user regarding a task of interest allows the user to determine what portion of the entire task said user is capable of completing, and what portion of said task the user feels more comfortable hiring to an expert of business. An educated user is able to subdivide a project based on the portions of a task that the use desires to complete and the portions of the task that the user will hire out to an expert or business. The educated user is thus able to save money on the overall project, thereby being more satisfied with the whole experience—including the portion of said task hired out to the expert of business. In addition, because the user saved money on the project, the user has freed up funds for hired assistance with other tasks. Unfortunately, using the promotional material of the prior art, a user is left uninformed regarding a project, and will often either have to turn the project over to an expert or business for completion or will entirely cease the project's completion because said user is frustrated, financially unable to move forward, or both.

Informational books, such as how-to books, attempt to educate the user about how to perform a task of interest. Examples of instructional books include Chilton® Manuals and the For Dummies® series. Using the above example of a performance automobile, a user can purchase an instructional book about how to build such an automobile. The instructions are generally detailed based on the author's experiences and perspective working with such projects. Unfortunately, not all users will have the same understanding, experiences and perspective of a project, and thus a specific user may not be completely informed or adequately skilled to complete a task given a generalized set of instructions. Thus, the assumption that all users will equally and thoroughly understand the instructions on how to accomplish the task of interest is flawed. As a result, many users of instructional books are incapable of completing a task given the instructions provided. In these situations, the user becomes dissatisfied with the publication and will not speak favorably about said publication. In addition, a user may become frustrated and tired with the project and will not complete the task. Such outcomes based on the prior art are undesirable.

Thus, there is a long felt need for specifically, directly and succinctly providing users a publication which integrates instruction and resources for assistance. The need in the art further requires that the instructions are thoroughly detailed to provide adequate information to a user regarding how to complete a task of interest; and additionally, that the instructions can be optimized to fit the needs of an individual user. Further, the need in the art includes delivering expert and business resources to a user that allows said user to contact a business or expert who specializes directly in the problem that a user may encounter, allowing said user to engage the expert of business to instructionally or physically assist with a specific subset of a task.

### SUMMARY OF THE INVENTION

The invention creates a new paradigm for delivering instructional information and directed advertising to a user regarding a task of interest. The instructional and promotional information is delivered in printed and, alternatively, electronic medium. The invention is a novel resource for a general or specific area that places experts or businesses specializing in that general or specific area in direct proximity to instructional information, thus allowing one interested in the information to contact and/or transact business with the expert or business.

In one embodiment, the present invention comprises a publication that is instructional with respect to a subject matter field and that is promotional with respect to the same subject matter within the subject matter field. In this embodiment, specific instructions are given to the user of said publication allowing said user to complete or substantially complete a task relating to a subject matter of interest. The promotional aspect of said publication is such that the user can also obtain direct and advice or assistance from experts and business operating in said subject matter field. The experts and businesses know the text, and may have even written the text, thus allowing the user and expert to engage in meaningful, direct and specific communication with respect to said subject matter. The user and expert and/or business may further enter into a business relationship regarding said subject matter.

One embodiment of the present invention relates to an electronic media based publication that is instructional and promotional. In this alternative embodiment, the instructional text and the promotional text are presented electronically allowing a user to review specific instructions on how to accomplish a task and also allowing a user to seek specific and directed advice and assistance from experts and businesses in the subject matter field. A particular aspect of this alternative embodiment can be employed wherein the instructional text and the promotional text can be presented to the reader such that the instructional text initially comprises the entire viewing area. In this aspect, the promotional text is embedded behind the instructional text such that promotional text is hidden. Promotional text can be pulled up and is available for viewing upon demand by the user.

The current invention is further described below and in the appended claims.

### BRIEF DESCRIPTION OF THE DRAWINGS

FIG. 1 shows a block view of the instructional and promotional publication of the preferred embodiment.

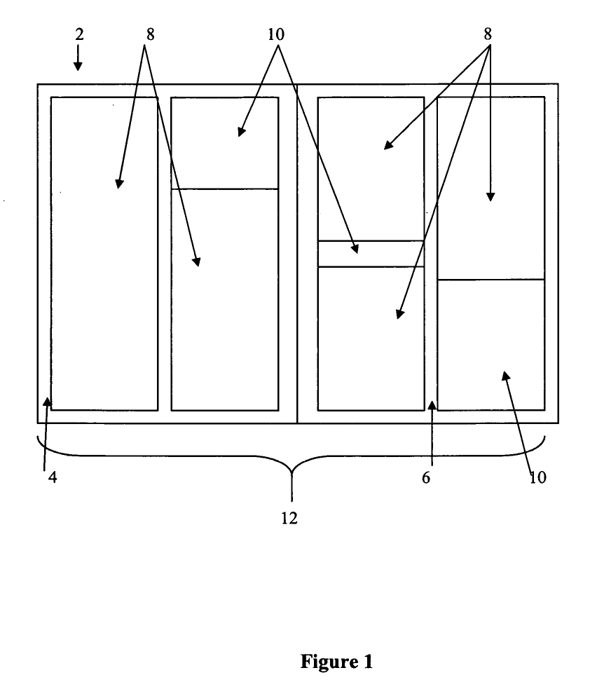

FIG. 2 illustrates a further embodiment of the current invention wherein the instructional text and promotional text are provided electronically and the instructional text comprises the entire viewing field.

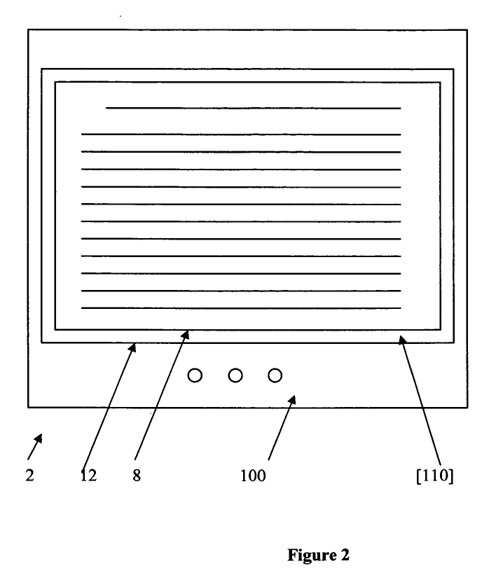

FIG. 3 illustrates an alternative embodiment of the current invention wherein the instructional text and promotional text are provided electronically and a ratio thereof comprises the viewing field.

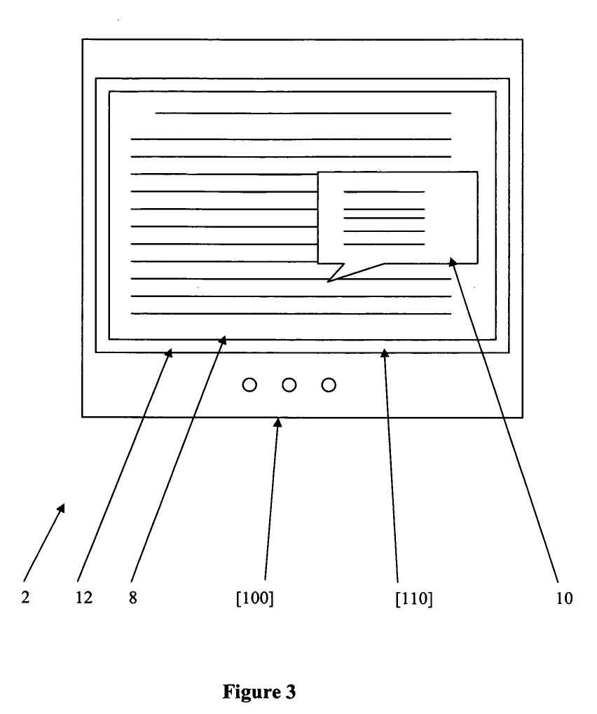

### DETAILED DESCRIPTION OF THE INVENTION

Abbreviations and Terms

In accordance with the present invention and as used herein, the following terms and abbreviations are defined with the following meanings, unless explicitly stated otherwise. These explanations are intended to be exemplary only. They are not intended to limit the terms as they are described or referred to throughout the specification. Rather, these explanations are meant to include any additional aspects and/or examples of the terms as described and claimed herein.

The following abbreviations are used herein:

The term “subject matter field” refers to a topic or topic of interest such as home improvement, lawn and garden, health and fitness, auto repair, auto maintenance, yachting, computer repair, computer programming, computer use, wood working, crafts, knitting, outdoor activities, and the like.

The term “subject matter” refers to more specific instances within the subject matter field. For example a publication on home improvement may have several chapters, one chapter may be on home improvement in general, in the example subject matter refers to home improvement in general. In another example a publication on home improvement may have a chapter on flooring, in this example subject matter refers to flooring.

The term “sufficient useful detail” refers to the detail necessary for an average user with an interest in the subject matter and average knowledge and skills for said user to understand said subject matter or complete the task within said subject matter.

The term “strategically placed” refers to placing ads which are likely to be a benefit to the user of a publication and/or be a benefit to the advertiser, because of a relationship between the area of expertise of the advertiser and the subject matter in which the advertisement is placed.

The term “network” refers to a one or more of professionals who are experts within a subject matter and are identified within that subject matter as being approachable for advice and add to or modify the instructional text as a result of communications with users.

The term “professionals who are able to customize” refers to professionals who add to or contribute the content of the instructional text within the subject matter in which the professional is an expert an in which said professional places an advertisement.

The term “manage the subject matter” refers to a users having sufficient knowledge as a result of the instructional text to understand a subject matter or complete a task within said subject matter.

The term “generalized but detailed instruction” refers to a subject matter in a broad context. When providing generalized instruction it is important to give the instruction to a large group of users needing instruction in said subject matter. Instruction can be provided on how to replace something, such as household appliance, and describing the procedures in such a way as to cover many different household appliances made by several different manufactures. While the instruction is general enough to cover many different situations, such as different makes of household appliances, different car makers when replacing automobile parts, and the like, the instructions are also specific enough to complete the task.

The term “call up” refers to embedded information within a web page or hyperlink to another web page, where the user clicks on the embedded information with a computer mouse and like technology.

The term “viewable field” refers to the viewable portion of a publication. For example, in a book, the viewable field is those two pages that are apparent to the user's when a book is open. When used with an electronic format, viewable field is the entire viewable area containing electronic text, regardless of whether it is necessary to scroll up or down to actually view the text in said viewable field. However, a single viewable field in electronic format does not include more that one page of a document presented in WORD®, Adobe® or Word Perfect® or the like, as such formats have clearly defined pages, and thus, each page is a viewable field. Similarly, with respect to a web page, a single viewable field only includes the entire visible text on a web page, and does not include the text on pages that require a hyperlink or separate web address to further view.

The term “professional” refers to an expert of business specializing in the subject matter of the instructional text. The professional or a third party, such as an advertising agency, a graphics company or a publishing company, will provide the graphic art or text containing the identity of the company for the promotional text. In addition, professionals are familiar with the specific content of the instructional text, and in some instances are the authors of said instructional text.

The term “instructional information” refers to instructive information on a subject of interest, commonly referred to as “how-to.” Instructional information includes without limitation instructional information related to: home improvement, home decorating, home construction, gardening, landscaping, nutrition, fitness, crafts, hobbies, cooking, outdoor activities, indoor activities, automobiles, boats, parenting, dating, aging, sports, legal, financial, computers, technology, and the like.

The term “instructional text” refers to the text used to communicate instructional information.

The current invention encompasses an instructional and promotional document offering detailed instruction regarding how to accomplish a task and offering promotion of professionals whose services are directed towards the subject matter of the instruction. Common promotional publications are typically long lists of experts and business relating to a particular subject matter field. One example of such a list is the Yellow Pages® telephone directories. Further examples include advertisement flyers and newspaper and magazine advertisements. Unfortunately, these lists of experts and businesses rarely do more than promote the services an expert or business provides. And although the advertisements may be in a publication relating to the subject matter, such as advertisements for home remodel businesses in a magazine relating to house design ideas, these advertisements are merely related in subject matter field only are not directly targeted to the content of said publication.

The present invention provides an organizational framework for the communication and/or presentation of said instructional and promotional information. The advertisers are professionals who are intimately familiar with the subject matter of the instructional text. The advertisements of professionals are strategically placed throughout the publication so that their expertise is directly related to the subject matter of said publication. The professionals are familiar with the content of the instruction near which they are placed, and can offer advice on the specific instruction. In some instances the professionals have written the instructional text, and are thus very familiar with its specific content. With the current invention, a user can contact the professional and ask specific questions about the instructional text and the professional will give directed and specific answers. Furthermore, the user can request that the professional complete the task for the user.

Similarly, the current invention is unlike the common instructional publications of the prior art (e.g., the For Dummies® series published by John Wiley & Sons) because the current invention does not merely present the information to the reader and assume that all readers will equally and thoroughly understand the instruction on how to accomplish the task of interest. The instructional publication of the current invention provides along with the instructional text a listing of professionals specializing in said subject matter. Many of these professionals are the contributors to said instructional text. All of the professionals are very familiar with the text and are placed proximate said text. By having read and reviewed (an in some instances, contributed) to the text, the professionals are able to provide very specific and directed assistance with a project relating to the instructional text. Thus, the advantage of the current invention over the instructional publications of the prior art is that the user can attempt to accomplish the task presented in said instructional publication; however, should the user find that the task is more difficult that anticipated, is not explained so that said user can understand the instructions, is more time consuming than anticipated, or, for whatever reason, is one that said user is not interested in personally completing, then said user can contact the professionals listed immediately next to said instructional text. These experts having read the text and agreed to form part of the instructional/promotional network, are more than able and willing to respond to questions about the task or can be hired to complete the task. The professional within the network will make changes to the text based on specific needs of the user. Requests for information will help the expert within the network add information that many users have a need for or change information that is unclear or lacks sufficient detail to complete a task.

In one embodiment, the invention is a written publication similar to a pamphlet, book or magazine. The publication instructs a user on how to complete a task, and offers specific, detailed assistance in the form of advertisements of professionals specializing in the subject matter field of the publication's content. The publication further to promotes the services of professionals in the subject matter field, in that the professionals are prepared to assist a user via enhanced and customized instructional assistance for the subject matter task, and further, allowing the user and the professional to arrange a business relationship for an agreed upon portion of the subject matter task.

In one embodiment, the invention comprises at least one page further comprising a combination of instructional and promotional text. FIG. [1] shows an exemplary instructional and promotional publication [2] wherein at least one page is in the form of a book having left and right pages [4] and [6], respectively. Text is placed on said at least one pages, and is a combination of instructional and promotional text. For example, in FIG. [1], left page [4] has instructional text [8] and promotional text [10] and right page [6], similarly has instructional text [8] and promotional text [10]. Thus, viewable field [12], which is a combination of left page [4] and right page [6] in this embodiment, comprise both instructional text [8] and promotional text [10].

Instructional text [8] teaches a user how to accomplish a task of interest. For example, instructional text [8] could instruct the user how to install an industrial size hot water heater in a commercial building. Instructional text [8] is thoroughly sufficient to allow many users to complete the task without the assistance of a professional. However, not every user is of the same skill level with regards to installing an industrial hot water heater, and so, not every user will be able to complete the task based solely on instructional text [8]. Similarly, not every installation of an industrial hot water heater into a commercial building is the same. Thus, some projects will require instructions that are customized to meet the differences of that particular project. The current invention provides the generalized but detailed instructions for completing a task in combination with a list of professionals who are able to customize said generalized instructions and who are willing to perform the task themselves.

Promotional text [10] is a list of predetermined professionals familiar with the subject matter of the instructional text [8]. It is not necessary that every of the professionals listed in promotional text [10] have contributed to the text of instructional text [8]. Promotional text [10] can be simple listings of the professional's name and contact information, or promotional text [10] can be more detailed, listing information such as the years experience or the section of instructional text [8] to which the professional contributed. Promotional information listed by a professional in promotional text [10] can be variable. Those of ordinary skill in the art will appreciate that a variety of promotional material may be placed into promotional text [10], all within the spirit of the current invention.

When using the invention instructional and promotional publication [2], the user will attempt to perform the task of the instructional text [8]; however, if a section of the instructional text [8] is unclear or needs to be adapted to the specific task the user is performing, then the user can contact one of the professionals in the promotional text [10]. For example, the instructional text [8] describing how to install an industrial hot water heater in a commercial building will not account for the variation of every user's commercial building with respect to installation of an industrial hot water heater. In such a situation, the user will need specialized advice regarding how to adapt the teachings of instructional text [8] to the particular task. The user can then review the promotional text [10] and contact one of the professionals for advice regarding how to adapt the teachings to fit the user's situation. The professional, being familiar with the text and subject matter of instructional text [8], will then guide the user through the specific customizations necessary to perform the user's specific task. Should the adaptation prove to be very complex or, should the user not have the understanding or patience to continue the task, then the user can arrange to have the professional assist with that portion of the task. The professional's help, therefore, is crafted to specifically address the task, and further to enter into a business relationship for only the portion of that task that a user requires assistance.

In one embodiment, instructional text [8] and promotional text [10] are printed on viewable field [12] in a ratio that allows the professionals in promotional text [10] to co-present in viewable field [12] along with the instructional text [8] to which said professional specializes or has contributed. In the preferred embodiment said instructional text [8] is about 75 percent of viewable field [12] and said promotional text [10] is about 25 percent of viewable field [12]; more preferably about 85 percent and about 15 percent, respectively, and most preferably about 95 percent and about 5 percent, respectively. The specific ratios of instructional text [8] to promotional text [10] in the viewable field [12] will depend on a variety of factors, including but not limited to marketing constraints, aesthetics and user friendliness.

In one embodiment, viewable field [12] comprises a left page [4] and right page [6] and is formatted similar to a book, wherein left page [4] and right page [6] are aligned about a shared spine. Thus, the instructional and promotional publication [2] can comprise a plurality of left page [4] and right page [6], thereby forming a book having multiple viewable fields [12]. Alternatively, the instructional and promotional publication [2] can comprise a single left page [4] and right page [6], thereby forming single viewable fields [12]. The format of the instructional and promotional publication [2] can be variable, and those of ordinary skill in the art will readily embody the current invention in a variety of formats without exceeding the scope of the current invention.

In a further embodiment the instructional and promotional publication [2] is in an electronic medium, such as an electronic book, an e-zine, a web page, or similar medium. Here, the viewable field [12] can comprise instructional text [8] with embedded promotional text [10]. In this embodiment, seen in FIG. [2], the user will work on a task using the guidance set forth in the instructional text [8]. In FIG. [2], the example is instructional text [8] presented on the screen [110] of a personal computer [100]. Because this embodiment embeds promotional text [10], instructional text [8] can comprise as much as 100 percent of viewable field [12] when the user is primarily relying on the guidance of said instructional text [8]. Should the user encounter a problem and desire to consult or hire a professional, then the user will call up the embedded promotional text [10]. For example, when the electronic medium is viewed using a computer [100], the user can call up the embedded promotional text [10] by placing the cursor over the portion of instructional text [8] that is problematic. The cursor will indicate to the electronic device that the user is interested in reviewing the promotional text [10], and will bring forward to the viewable field [12] a list of professionals for that particular portion of the task. FIG. [3]. The embedded promotional text [10], once pulled to the viewable field [12] can either comprise 100 percent of the viewable field [12], or can exist as a portion of viewable field [12] along with the instructional text [8].

Those of ordinary skill in the art will readily employ a variety of well known techniques for embedding and bringing forward the promotional text [10]. Such techniques are within the scope of the current invention disclosure.

For example, instructional and promotional publication [2] can be in the form of a how-to book. A user who is interested in remodeling a bathroom in said user's home could obtain a copy of an instructional and promotional publication [2] of the current invention that instructs on how to accomplish such a task. Said use can begin the task of remodeling the bathroom using the guidance presented in instructional text [8]. Instructional text [8], in this example, can be just words, just graphics, or a combination of words and graphics designed to assist with accomplishing the task of remodeling a bathroom. Should the user encounter a problem with understanding the instructional text [8], or should the user have a bathroom that presents a unique problem not discussed in instructional text [8], then the user can seek additional guidance from a professional listed in promotional text [10]. Further, should the user desire that a professional complete a portion of the bathroom remodel task, then too, will the user resort to the professionals listed in promotional text [10]. Other instructional and promotional publications [2], formatted as magazines, brochures, newspapers, electronic medium or other common medium, will be similarly used by the user.

Various modifications and alterations of the invention will become apparent to those skilled in the art without departing from the spirit and scope of the invention, which is defined by the accompanying claims. For example, it should be noted that steps recited in any method claims below do not necessarily need to be performed in the order that they are recited. Those of ordinary skill in the art will recognize variations in performing the steps from the order in which they are recited. For example, in certain embodiments, steps may be performed simultaneously. The accompanying claims should be constructed with these principles in mind.

1. A publication for delivering information and assistance information to a reader comprising:
a. one or more sheets;
b. a viewable field;
c. promotional text; and
c. instructional text;
wherein said publication has sufficient detail within said instructional text to allow said reader to request assistance from at least one professional specializing in the subject matter field of said instructional text.

2. The publication of claim 1, wherein one or more of the sheets further comprises text within the viewable field.

3. The publication of claim 2, wherein said text is instructional and promotional, and wherein said instructional text comprises between about 5% and about 95% of the viewable field.

4. The publication of claim 2, wherein said text is instructional and promotional, and wherein said instructional text comprises between about 15% and about 85% of the viewable field.

5. The publication of claim 2, wherein said text is instructional and promotional, and wherein said instructional text comprises between about 25% and about 75% of the viewable field.

6. The publication of claim 2, wherein said text provides instructions on completing a task and promotes professionals specializing in said task thereby allowing for customization of and assistance with said task.

7. The publication of claim 6, wherein said text instructs how to substantially complete a task in the subject matter field selected from the group comprising: home improvement; lawn and garden; health and fitness; auto repair; auto maintenance; boat maintenance; yachting; computer repair; computer programming; computer use; wood working; crafts; and knitting.

8. The publication of claim 7, wherein said text promotes professionals specializing in the same subject matter field as that selected from said group.

9. The publication of claim 8, wherein the instructional and promotional text is presented in the same viewable field.

10. The publication of claim 1, wherein the instructional and promotional text is embodied as electronic media within the viewable field.

11. The publication of claim 10, wherein said electronic media further comprises hyperlinks to said instructional text, to said promotional text or to both said instructional and said promotional text.

12. A method for delivering instructional and promotional information to a user, wherein said instructional and promotional information delivered via a printed publication having a plurality of pages, comprising the steps of:
a. placing instructional text on at least one page of a publication
b. placing promotional text on at least one page which is related to the instructional text of step (a);
c. placing said promotional text sufficiently near said instructional text such that the user can coincidentally review instructions and promotions relating to the same subject matter field.

13. The method of claim 12, wherein said instructional text comprises instructions on substantially completing a task in a subject matter field selected from the group comprising: home improvement; lawn and garden; health and fitness; auto repair; auto maintenance; boat maintenance; yachting; computer repair; computer programming; computer use; wood working; crafts; and knitting.

14. The method of claim 12, wherein said promotional text comprises listings of expert services and businesses specializing in the same subject matter field as that selected from said group.

15. A method of doing business comprising:
collecting information about a particular subject matter field;
preparing the publication of claim 1 which contains the information collected; and
publishing the publication thereby making them available to a user having an interest in the subject matter field of the publication.

16. The publication of claim 1 which is implemented in silico.

17. The publication of claim 16 wherein in silico implementation is over a computer network.
